(19) United States
(12) Patent Application Publication
(10) Pub. No.: US 2026/0242187 A1
(43) Pub. Date: Aug. 20, 2026

(54) A Method and an Auxiliary Boom for a Crane System

(71) Applicant: LIFTRA IP APS, Aalborg SV (DK)

(72) Inventors: Per Eske Fenger, Terndrup (DK); Ion Pirlea, Aalborg SV (DK); Thomas Lehmann Sørensen, Aalborg SV (DK); Robin Krogh Olesen, Aalborg SV (DK)

(21) Appl. No.: 19/165,292

(22) PCT Filed: Mar. 15, 2024
(86) PCT No.: PCT/EP2024/057026

§ 371 Date: Sep. 15, 2025

(30) Foreign Application Priority Data
Mar. 15, 2023 (DK) PA202370133

(51) Int. Cl. B66C 23/68; B66C 23/26; B66C 23/70

(52) U.S. Cl. CPC B66C 23/68; B66C 23/26; B66C 23/702

(57) ABSTRACT

A crane system has an auxiliary boom. The auxiliary boom includes base attachment means, tip engagement means configured to receive to the main boom's tip end in an engagement position, and wire handling means, arranged in the hoisting end. The wire handling means is configured to receive a main wire from a main boom. The auxiliary boom may include connection means configured for connection to the main boom's moving means, such that the crane system is capable of controlled said auxiliary boom with the moving means for the main boom, and the crane system's is capable of using the main wire for hoisting a load. The crane system's lifting capacity and/or lifting radius are defined by the auxiliary boom.

### CROSS-REFERENCE TO RELATED APPLICATIONS

This application is the national phase of, and claims priority to, International Application No. PCT/EP2024/057026, filed 15 Mar. 2024, which claims priority to Danish Patent Application No. PA 2023 70133, filed 15 Mar. 2023.

### FIELD OF INVENTION

The invention relates to an auxiliary boom for a crane system, and a method for installing an auxiliary boom to a crane system.

### BACKGROUND OF THE INVENTION

The assembly, maintenance, and parts replacement are time-consuming, expensive, and disruptive in many industries. The crane system may not meet the requirements of a hoisting task for lifting and lowering a load due to the limited size of the crane system. This applies specially to crane systems, which are arranged on high building constructions, such as high-rise buildings, a bridge, or on top of a wind turbine. The crane system may have a load capacity that does not comply with a specific hoisting task, especially a heavy lift task. Furthermore, the crane system may have a limited lifting radius for handling a specific hoisting task. The crane systems are often smaller crane systems with limited hoisting capacity, such as limitation in load capacity.

The document EP3020622 A1 describes a solution for lifting loads of varying weight by increasing the load capacity. The crane system comprises a crane with a boom, and a lifting unit. Either the crane or the lifting unit comprises an auxiliary winch and wire assembly for mounting the lifting unit to the crane boom. The lifting unit must be lifted up to the crane boom and an auxiliary winch must be attached to the lifting unit before the listing unit can be installed to the boom. Furthermore, the lifting unit must comprise a wire for hoisting purposes. The crane system controls the movement of the lifting unit by controlling the boom. The crane system must be prepared for controlling the lifting unit's wire and comprising means for driving the lifting unit's wire. The installation is very time consuming due to the complex installing process. Even with the lifting unit installed in a position below the boom, the crane system still has a limited lifting radius. The hoisting operations are therefore still limited. The document EP3020622 A1 provides an expensive solution, wherein the installation process is complicated and time consuming, and wherein the operations require a separate hoisting equipment during operation, such as wire for lifting and auxiliary control equipment for controlling the lifting unit.

### SUMMARY OF THE INVENTION

It is an object of the invention to overcome these problems by providing a method for agile installation of an auxiliary boom in a crane system. The object of the invention is, furthermore, to provide a robust auxiliary boom, such that the crane system is capable of increasing the load capacity and/or the lifting radius.

The invention addresses this by providing a method for installing an auxiliary boom in a crane system, wherein the crane system comprises a main boom, a crane base and a main wire, wherein the method comprises following steps:
providing the auxiliary boom, wherein the auxiliary boom comprises a hoisting end, a base end, a boom part, wherein the boom part is arranged between the hoisting end and the base end, and at least one wire handling means,
arranging a main wire in a hoisting grip in said wire handling means at the hoisting end of the auxiliary boom,
hoisting the auxiliary boom using the main wire, wherein a hoisting position of the auxiliary boom is determined by the auxiliary boom's center of gravity,
arranging the auxiliary boom or part of auxiliary boom relative to a main boom, when holding the auxiliary boom with the main wire,
attaching the auxiliary boom to the main boom and/or to the crane base, when holding the auxiliary boom with the main wire, in a position wherein the auxiliary boom or part of the auxiliary boom is arranged along the main boom, and
arranging the main wire in and/or through the auxiliary boom's wire handling means, such that the crane system's lifting capacity is defined by the auxiliary boom, while using the main wire for hoisting a load.

The demand for agile and light-weighted crane systems within the high construction industry has increased significantly over the years. Challenging areas and increasingly heavy components create great challenges for high construction installation and maintenance. The crane system may be arranged on the top of the high construction. The crane systems must be easy and agile to install, such that the installation time is reduced. During operation, the crane must still have a high load capacity, such that the crane system is capable of handling the required heavy load. The method provides an installation of an auxiliary boom in a crane system, which is fast and reliable, which reduces the installation time and thereby the installation costs as well. The crane may be arranged in situ, for example on a tall construction such as a high-rise building, a bridge or on top of a wind turbine.

The crane system comprises a main boom, a crane base, and a main wire. When the auxiliary boom is installed in the crane system, the crane system has increased the load capacity and/or lifting radius. The auxiliary boom comprises a hoisting end, a base end, a boom part, wherein the boom part is arranged between the hoisting end and the base end. The auxiliary boom also comprises at least one wire handling means for handling the crane system's main wire, both during operation and when the auxiliary boom is being installed in the crane system. When the auxiliary boom is being installed in the crane system, the main wire is arranged safely with a hoisting grip in the wire handling means at the hoisting end of the auxiliary boom. Now the crane system can hoist the auxiliary boom with the main wire.

The auxiliary boom or part of the auxiliary boom is arranged in a substantially parallel position to a main boom, when holding the auxiliary boom with the main wire in the hoisting end of the auxiliary boom. The auxiliary boom or part of the auxiliary boom is attached to the tip end of the main boom and to the base end of the main boom. The auxiliary boom or part of the auxiliary boom may alternatively be attached to the tip end of the main boom and to the crane base. The main wires hold the auxiliary boom, until the auxiliary boom is safely attached to the crane system in a substantially parallel position to the main boom. The main wire is arranged relative to or in the auxiliary boom's wire handling means. The crane system may operate the crane using the auxiliary boom as an enhanced main boom. The crane system may use the main wire as such, whereas the crane system now has the lifting capacity of the auxiliary boom, while using the main wire for hoisting a load. The term “wire” is to be understood in its broadest sense, wherein the main wire may comprise cable, wire rope, chain, rope and other types of lifting medium.

Maintaining or building wind turbines at a lower overall cost with much less environmental impact reinforces wind energy as a competitive alternative to fossil fuels. Maintaining or building high-rise buildings at a lower overall cost is also a competitive alternative.

In an advantageous method of the invention, the method provides a further step by pulling the main wire through or around a further wire handling means arranged between the hoisting end and the base end of the auxiliary boom, to the wire handling means at the hoisting end of the auxiliary boom.

The main boom may be an installation boom. The installation boom may be provided to install an auxiliary boom, which is intended for being a main boom in the crane system. The auxiliary boom may be provided with a further wire handling means. The auxiliary boom may have a length longer than the length of the main boom. The further wire handling means may be arranged in a position between the hoisting end and the base end of the auxiliary boom. The main wire is pulled through or around the further wire handling means and forwarded to the wire handling means at the hoisting end of the auxiliary boom.

When the auxiliary boom may be hoisted into a position substantially parallel to the main boom, the hoisting end of the auxiliary boom may be arranged in an elevated position relative to the main boom's tip end. The further wire handling means of the auxiliary boom may be arranged substantially adjacent to the main boom's tip end.

The main boom may be capable of hoisting the auxiliary boom, such that the auxiliary boom when being engaged to the tip end of the main boom may have a predetermined length from the tip engagement means to the base attachment means that equals the length from the tip end of the main boom to the crane base wherein the base attachment means may be connected to the crane base. The further wire handling means may therefore be arranged in a predetermined position between the hoisting end and base end of the auxiliary boom, such that the main boom may be capable of lifting the hoisting end higher up than the tip end of the main boom.

In a further advantageous method of the invention, the method provides further steps of:
using the main wire for hoisting the auxiliary boom up to a tip end of the main boom,
lifting the tip end of the main boom relative to the base end of the main boom, while positioning the auxiliary boom in a position substantially parallel to the main boom, and/or
attaching the auxiliary boom to the main boom and/or crane base in a releasable locked position, while the auxiliary boom and main boom are in an upright position.

The main wire is used for hoisting the auxiliary boom up to the tip end of the main boom. The main boom is boomed into a substantially elevated position. While tensioning the main wire, the crane system is capable of positioning the auxiliary boom next to the main boom. The crane system is capable of positioning the auxiliary boom in a position substantially parallel to the main boom, when the rope is tensioned. The auxiliary boom is positioned in an upright position substantially parallel the main boom and/or crane base, such that the auxiliary boom is in a releasable locked position. The auxiliary boom may be releasable locked to the main boom and/or crane base.

“Upright position” shall be understood as lifting up the tip end of the main boom relative to the base end of the main boom.

In a still further advantageous method of the invention, the method provides further steps of attaching the tip end of the main boom to at least one tip engagement means provided on the auxiliary boom.

While the auxiliary boom is being hoisted into an upright position substantially parallel the main boom, the tip engagement means engage the tip end of the main boom. The tip end of the main boom may comprise a complementary engagement means which may be configured to engage the tip engagement means on the auxiliary boom in an engagement position.

Alternatively, the auxiliary boom is positioned in an upright position substantially parallel to the main boom. When the main wire is loosened, the auxiliary boom may move downwards due to the force of gravity. When the main wire is loosened, the auxiliary boom may move into the releasable locked position wherein the tip engagement means engage the complementary engagement means provided on the tip end of the main boom.

When the auxiliary boom and the main boom have engaged, the base end of the auxiliary boom may be directed towards the crane base due to the movement of the auxiliary boom relative to the main boom. When the base end is in a releasable locked position at the crane base, the releasable locking means is engaged.

In a still further advantageous method of the invention, the method provides further steps of:
attaching the main boom to at least one moving means to the auxiliary boom, and/or
using moving means to operate the auxiliary boom.

The main boom and the main wire are controlled by the crane system, by using one or more moving means. The moving means may be attached to the main boom at the crane base. The moving means may be disconnected from the main boom and reconnected to the auxiliary boom, such that the auxiliary boom may be controlled as a new enhanced main boom, provided with all or mostly all of the functions of the main boom. The crane system may control the auxiliary boom and the main wire via the auxiliary boom.

In a second aspect of the invention, the invention provides an auxiliary boom for a crane system, wherein the auxiliary boom comprises:
a hoisting end and a base end, and a boom part, which is arranged between the hoisting end and the base end,
at least one base attachment means, which is arranged at the base end, wherein the base attachment means is configured to be attached to the crane base,
at least one tip engagement means, which is arranged at a position away from base attachment means, wherein the tip attachment means is configured to receive the main boom's tip end in an engagement position, and/or
at least one wire handling means, wherein at least one of the wire handling means is arranged in the hoisting end, wherein the wire handling means is configured to receive a main wire from a main boom.

The auxiliary boom comprises a hoisting end and a base end, and a boom part, which is arranged between the hoisting end and the base end. The auxiliary boom also comprises base attachment means arranged at the base end of the auxiliary boom. The base attachment means may be configured to be attached to the crane base. Alternatively, the base attachment means may be configured to be attached to the base end of the main boom. The base attachment means may be configured to be attached near the center of rotation of the crane base.

The auxiliary boom comprises tip engagement means. The tip engagement means may be arranged in a predetermined position away from base attachment means. The tip attachment means may be provided in a predefined position between the hoisting end and the base end of the auxiliary boom. The tip attachment means may be adjustable along the longitudinal direction of the auxiliary boom. The tip attachment means may be configured to receive to the main boom's tip end in an engagement position. The tip attachment means may be configured to be releasably locked to main boom's tip end.

The auxiliary boom comprises wire handling means. The wire handling means is arranged in the hoisting end. The wire handling means is configured to receive the main wire from the main boom. The main wire may be controlled by the crane system during operation when hoisting a load. The wire handling means may comprise sheaves, rollers, pins or rails etc., such that the wire handling means is capable of guiding the main wire back and forth with very little resistance.

The auxiliary boom may be a telescopic boom, wherein the auxiliary boom is configured to extend the length of the auxiliary boom. In this way the auxiliary boom is configured to further extend the lifting radius of the crane system. The crane system may control the lifting radius relative to the load to be hoisted.

In an embodiment of the invention, the tip engagement means is provided at the hoisting end, or between the hoisting end and base end.

The tip end may comprise a complementary engagement means which may be configured to engage the tip engagement means on the auxiliary boom in an engagement position. The predefined position of the tip attachment means may be determined by the length of the auxiliary boom relative to the length of the main boom. The tip attachment means may be adjustable along the entire auxiliary boom or along part of the auxiliary boom. The tip attachment means may be configured to receive the main boom's tip end in an engagement connection. The tip attachment means may be configured to be releasable locked to main boom's tip end.

The tip end of the main boom and the hoisting end of the auxiliary boom may come in contact, such that the complementary engagement means on the main boom and the tip engagement means on the auxiliary boom is capable of sliding towards each other in an engagement direction to be engaged in a retained position or releasable locked position.

In a further embodiment of the invention, a further wire handling means is arranged in a predetermined position between the hoisting end and base end of the auxiliary boom, such that a center of gravity of the auxiliary boom is placed between the further wire handling means and the base end of the auxiliary boom.

The auxiliary boom may be longer than the main boom. The main boom may be capable of hoisting the auxiliary boom, such that the auxiliary boom when being engaged to the tip end of the main boom, may have a predetermined length from the tip engagement means to the base attachment means that equals the length from the tip end of the main boom to the crane base, wherein the base attachment means may be connected to the crane base. If the auxiliary boom is longer than the main boom, the main boom may lift the hoisting end higher up than the tip end of the main boom. The further wire handling means may therefore be arranged in a predetermined position between the hoisting end and base end of the auxiliary boom. The tip engagement means on the auxiliary boom may be arranged relative to the further wire handling means, such that the tip end of the main boom's complementary engagement means engages with the tip engagement means on the auxiliary boom relative near the further wire handling means.

In a still further embodiment of the invention, the auxiliary boom is configured to partially enclose a main boom or part of a main boom.

The auxiliary boom may be configured to enclose a main boom at least partially. The auxiliary boom may be configured to enclose the main boom's base part or a part of the main boom's base part. The auxiliary boom supports the main boom. The auxiliary boom may be configured to enclose a main boom partially or fully. The main boom and the auxiliary boom may follow a common movement synchronously. The main boom and the auxiliary boom may follow each other simultaneously relative to the crane boom.

The hoisting process of the primary load may be mostly only handled by the auxiliary boom. Alternatively, the hoisting process of the primary load may be only handled by the auxiliary boom. The primary load may be only handled by the auxiliary boom. The main boom may comprise a longitudinal axis, which is substantially parallel to a longitudinal axis of the auxiliary boom. The longitudinal axis of the main boom may partially overlay the longitudinal axis of the auxiliary boom.

When the auxiliary boom is mounted on or relative to the crane base, the auxiliary boom's center of rotation axis may be equal to the main boom's center of rotation axis. Alternatively, the auxiliary boom's center of rotation axis may be displaced relative to the main boom's center of rotation axis.

In a further embodiment of the invention, the auxiliary boom comprises a first and a second boom side configured to be arranged on each side of a main boom, wherein a base end of each of said first and said second boom side are configured to be arranged on each side of a crane base, said first and said second boom side comprising each a side end opposite the base end, which are connected to a hoisting part with a hoisting end.

The first boom side and the second boom side of the auxiliary boom part are configured to be arranged on each side of a main boom. The base end of each of said first and said second boom side are configured to be arranged on each side of a crane base. The side end of the first boom side and the side end of the second boom side are arranged opposite each of the respective base ends. The side end of the first boom side and the side end of the second boom side are connected to a hoisting part with a hoisting end. Alternatively, the side end of the first boom side and the side end of the second boom side are a part of the hoisting part with a hoisting end.

In a still further embodiment of the invention, the base end comprises at least one connection means for attachment to a crane base and/or a main boom's moving means, such that a crane system is capable of controlling the movement of the auxiliary boom during operation.

The base end comprises at least one first connection means, such that the base end or base end attachment may be attached to a crane base. The crane may then be capable of controlling the movement of the auxiliary boom relative to a center of rotation related to the auxiliary boom during hoisting operation.

The base end comprises at least one second connection means, such that the base end or base end attachment means may be attached to a main boom's moving means. The crane may then be capable of controlling the movement of the auxiliary boom, using the same moving means for the main boom during hoisting operation. The crane may then be capable of controlling the movement of the auxiliary boom directly, while the main boom is disconnected from the moving means. The moving means may be operated hydraulically, electrically and/or pneumatically driven.

In a third aspect of the invention, the invention provides a crane system for a construction building, wherein the crane system comprises a main boom and an auxiliary boom, wherein the crane system is configured to install an auxiliary boom to a main boom on a crane, wherein the auxiliary boom is configured to enclose at least partially a base end of said main boom.

A crane system may be used for hoisting operation related to construction buildings. The construction building may be a high building or a wind turbine or similar. The crane system may be arranged in a position elevated above ground. The crane system comprises a main boom. The main boom may not meet the requirements of a task. The main boom may have a load capacity and/or a radius less than needed for the specific task. The crane system is configured to install an auxiliary boom to a main boom on a crane using the main boom and the main wire. The auxiliary boom provides the load capacity and/or a radius needed for a specific task.

In a still further embodiment of the third aspect of the invention, a length in a longitudinal direction of the auxiliary boom is longer than a length in a longitudinal direction of the main boom.

The auxiliary boom may be longer than the main boom, such that the auxiliary boom may be arranged in a connection with the crane base and the main boom's complementary engagement means on the tip end is capable of engaging the tip engagement means on the auxiliary boom in an engagement position. The auxiliary boom may be configured to increase the load capacity of the crane system and/or the lifting radius of the crane system.

In a still further embodiment of the third aspect of the invention, the said auxiliary boom is configured to hoisting load using a main wire.

When the auxiliary boom is attached safely to the crane system, the crane system may be capable of controlling the auxiliary boom as an alternative to the main boom. The crane system may be capable of controlling the auxiliary boom and hoisting load using a main wire, wherein the main wire hangs from the wire handling means at the hoisting end of the auxiliary boom.

In a further embodiment of the third aspect of the invention, said auxiliary boom comprises at least one connection means configured for connection to a crane base and/or the main boom's moving means, such that the crane system is capable of controlling said auxiliary boom with the moving means for the main boom.

The auxiliary boom comprises at least one connection means configured for connection to a crane base and/or the main boom's moving means. The base end comprises at last one first connection means, such that the base end or base ends may be attached to a crane base. The crane may then be capable of controlling the movement of the auxiliary boom relative to a center of rotation related to the auxiliary boom during hoisting operation.

The base end comprises at least one second connection means, such that the base end may be attached to a main boom's moving means. The crane may then be capable of controlling the movement of the auxiliary boom using the same moving means for the main boom during hoisting operation.

The crane system is capable of controlling the auxiliary boom with the moving means for the main boom, without controlling the main boom.

This invention has now been explained with reference to a few embodiments and methods, which have only been discussed to illustrate the many varying possibilities achievable with the auxiliary boom for a crane system, and the method for installing an auxiliary boom to a crane system according to the invention.

### BRIEF DESCRIPTION OF THE DRAWINGS

The embodiments of the invention are described in the following with reference to:

FIG. 1a, b: Illustrating an embodiment of a crane system with and without an auxiliary boom from a side view.

FIG. 2a, b: Showing an embodiment of an auxiliary boom.

FIG. 3a, b: Illustrating an embodiment of a crane system having a main boom prepared for receiving an auxiliary boom.

FIG. 4 a, b, c, d, e: Showing a crane system installing an auxiliary boom using an installation method.

FIG. 5a, b: Showing a further embodiment of crane system installing an auxiliary boom.

FIG. 6: showing an embodiment of connecting moving means from a main boom to an auxiliary boom using connection means.

FIG. 7: Illustrating reconnection of a main boom's moving means to an auxiliary boom 3.

In the explanations of the figures, identical or corresponding elements will be provided with the same designations in different figures. Therefore, no explanation of all details will be given in connection which each single figure/embodiment.

### DETAILED DESCRIPTION

Embodiments of the invention are explained in the following detailed description. It is to be understood that the invention is not limited in its scope to the following description or illustrated in the drawings. The invention is capable of other embodiments and of being practiced or carried out in various ways.

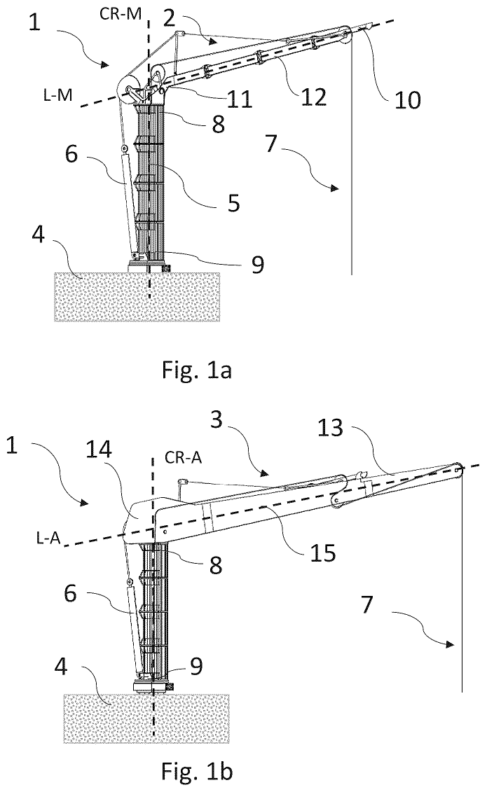

FIG. 1a , b illustrates an embodiment of a crane system 1 with and without an auxiliary boom 3 from a side view. The crane system 1 comprises a crane base 5 attached to a construction 4. The crane system 1 may be arranged on a building construction 4, such as a high-rise building, a bridge or a wind turbine.

FIG. 1a illustrates an embodiment of a crane system 1 with a main boom 2 prepared to receive an auxiliary boom 3. The main boom 2 may be an installation boom. The installation boom is used during installation of the crane system. The main boom 2 comprises a tip end 10, a base end 11, and a boom part 12. The boom part 12 is arranged between the tip end 10 and the base end 12 of the main boom 2. The base end 11 is attached to the upper end 8 of the crane base 5 and the crane base lower end 9 is attached to the construction 4. The crane system 1 comprises moving means 6 for moving the main boom 2 into a predetermined hoisting position. The crane system 1 has a center of rotation CR-M relative to the main boom. The crane system 1 comprises a main wire 7 for lifting loads. The main boom 2 is in one end attached to the crane base. The length of the main boom 2 is measured along the longitudinal direction L-M of the main boom.

FIG. 1b illustrates an embodiment of a crane system 1 with an auxiliary boom 3 connected to the main boom 2 and the crane base 5. The crane system 1 is capable of increasing the load capacity and/or lifting radius. The auxiliary boom 3 comprises a hoisting end 13, a base end 14, and a boom part 15. The boom part 12 is arranged between the hoisting end 10 and the base end 11. The auxiliary boom 3 encloses partially the main boom 2. The length of the auxiliary boom 3 is measured along the longitudinal direction L-A of the auxiliary boom 3. The length of the auxiliary boom 3 is longer than the length of the main boom 2. The longitudinal direction L-A of the auxiliary boom may be substantially parallel to the longitudinal direction L-M of the main boom. The crane system 1 has a center of rotation CR-A relative to the auxiliary boom.

The auxiliary boom 3 also comprises attachment means arranged at the base end 14 of the auxiliary boom 3. The attachment means is not showed in FIG. 1b. The base end 14 of the auxiliary boom 3 is attached to the upper end 8 of the crane base 5. Alternatively, the base attachment means may be attached to the base end 11 of the main boom 2. The base attachment means may be attached near the auxiliary boom's 3 center of rotation CR-A.

The auxiliary boom 3 comprises connection means for connection to a crane base and/or the main boom's 2 moving means, such that the crane system 1 is capable of controlling said auxiliary boom 3 with the moving means for the main boom 2.

The auxiliary boom 3 comprises connection means for connection to the main boom's moving means 6. The crane system 1 is capable of controlling the auxiliary boom with the moving means 6 provided for the main boom 2. The moving means 6 is released from the main boom 2 and attached to the auxiliary boom 3 with the use of connection means. The connection means is not illustrated in the FIG. 1b. When the auxiliary boom 3 is installed in the crane system 1, the main wire 7 is arranged such that the auxiliary boom 3 is capable of using the main wire 7 to hoist a load.

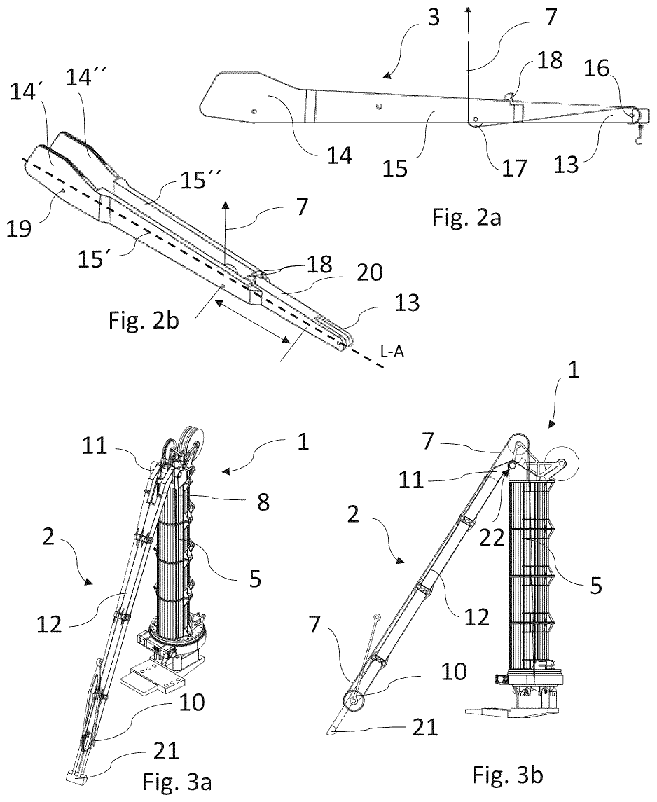

FIG. 2 a, b shows an embodiment of an auxiliary boom 3. The auxiliary boom 3 comprises wire handling means 16 for handling the crane system's 1 main wire 1, when the auxiliary boom 3 is being installed in the crane system 1. If the auxiliary boom 3 is substantially the same length as the main boom 2, the main wire 7 may be arranged in a hoisting grip relative to the wire handling means 16 at the hoisting end 13 of the auxiliary boom. In this embodiment the auxiliary boom 3 is longer than the main boom 2, the auxiliary boom 3 is prepared to be hoisted by the main wire 7, using a further wire handling means 17 arranged in a predetermined position on the boom part 15. Now the crane system 1 is ready for hoisting the auxiliary boom 3 with the main wire 7. The wire handling means 16 handles the crane system's 1 main wire 7 when the crane system 1 is performing the hoisting task, after the auxiliary boom 3 has been installed in the crane system 1. If the auxiliary boom 3 is longer than the main boom 2, as in this example, the main wire 7 is handled by the wire handling means 16 via the further wire handling means 17. The wire handling means 16 comprises a sheave and the further wire handing means 17 comprises a sheave, such that the main wire 7 is capable of rolling back and forth with very little resistance.

The auxiliary boom 3 comprises tip engagement means 18. The tip engagement means 18 is arranged at a predetermined position away from base attachment means 19 at the base end. The base attachment means 19 may comprise one or more apertures prepared for bolts or pins, such that the auxiliary boom may be easily attached to the crane base 5. The tip attachment means 18 may be provided in a predefined position between the hoisting end 13 and the base end 14 of the auxiliary boom 3. The predefined position of the tip attachment means 18 is determined by the length of the auxiliary boom 3 relative to the length of the main boom 2. The tip attachment means 18 may be adjustable along the entire auxiliary boom 3 or along a hoisting part 20 of auxiliary boom 3, as illustrated by the arrow. The tip attachment means 18 is capable of receiving the main boom's tip end 10 in an engagement connection. The tip attachment means 18 can be releasably locked to main boom's tip end 10.

The auxiliary boom 3 comprises wire handling means 16. The wire handling means 16 is arranged in the hoisting end. The wire handling means 16 is configured to receive the main wire 7 from the main boom 3. The main wire 7 may be controlled by the crane system 1 during operation when hoisting a load.

The auxiliary boom 3 comprises a first boom side and a second boom side of the auxiliary boom's 3 boom part 15. The first boom part 15′ and the second boom part 15″ are substantially parallel and are capable of being arranged on each side of a main boom 2, partially enclosing the main boom 2. The base ends 14′,14″ of each of the first and the second boom side are also capable of being arranged on each side of a crane base 5. The side end of the first boom side and the side end of the second boom side are arranged opposite each of the respective base ends near the hoisting end 13. The side end of the first boom side and the side end of the second boom side are connected to or a part of a hoisting part 20 with a hoisting end 13.

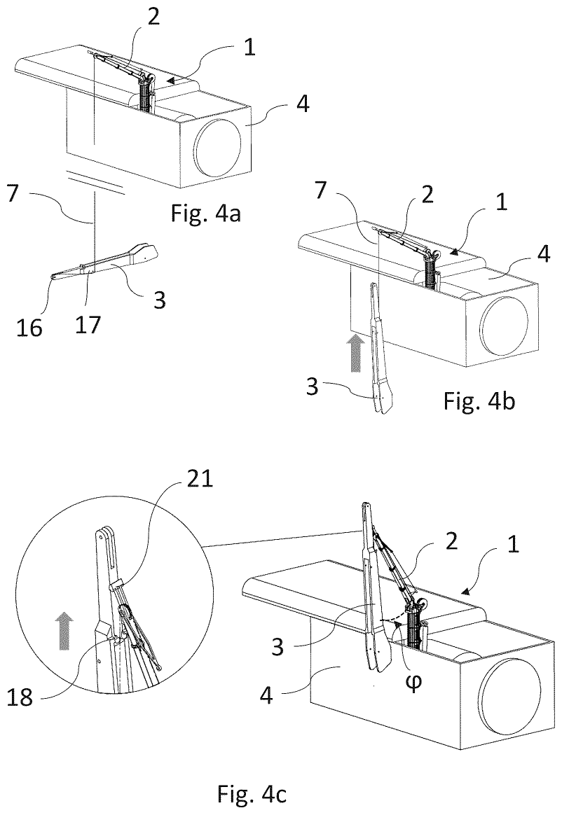

FIG. 3 a, b illustrates an embodiment of a crane system 1 having a main boom 2 prepared for receiving an auxiliary boom 3. As described in fig. la, the main boom 2 comprises a tip end 10, a base end 11, and a boom part 12. The base end 11 is attached to the upper end 8 of the crane base 5. The crane base may comprise a plurality of crane base elements forming a crane base tower. A complementary engagement means 21 is extending from the tip end 10 of the main boom 2. The complementary engagement means 21 is capable of engaging the tip engagement means provided on the auxiliary boom 3. The main wire 7 is extending from the crane base to the tip end of the main boom 2. The main boom is connected to the crane base with the use of further base attachment means 22.

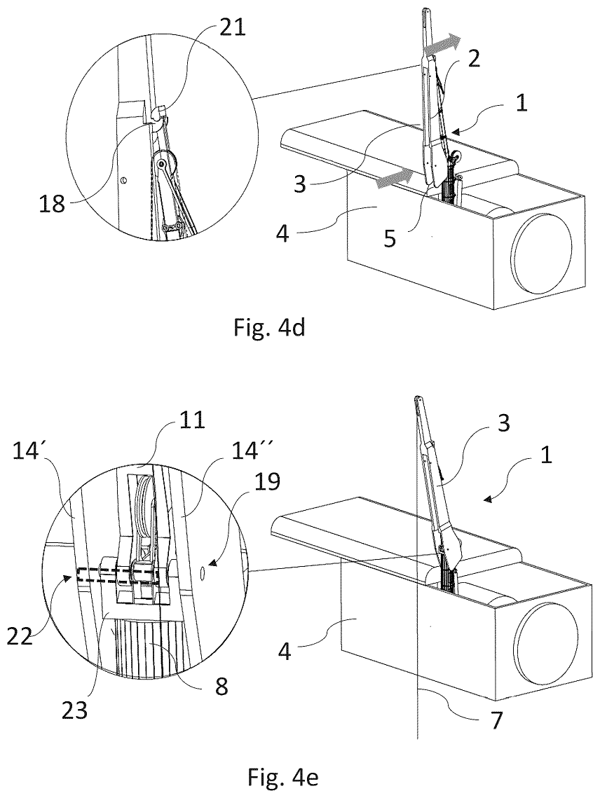

FIG. 4 a, b, c, d, e illustrates a crane system installing an auxiliary boom using an installation method. As illustrated in FIG. 4a, a crane system 1 is placed on top of and partially inside a construction 4, such as a wind turbine nacelle. The crane system 1 comprises a crane base 5, a main boom 2 and a main wire 7. The main boom 2 comprises complementary engagement means 21 extending from the tip end 10 of the main boom 2. An auxiliary boom 3 is provided, wherein the auxiliary boom 3 is longer than the main boom 2. The main wire 7 is attached via a further wire handing means 17 to the wire handling means 16 of the auxiliary boom 3 in a hoisting grip, such that the auxiliary boom 3 is prepared to be hoisted. The main wire is firstly pulled through the at least one further wire handling means 17 between the hoisting end 13 and the base end 14 of the auxiliary boom 3 to the wire handling means at the hoisting end 13 of the auxiliary boom 3.

The wire handling means 16 is a sheave and the further wire handing means 17 comprises two sheaves, such that the main wire 7 is capable of rolling back and forth with very little resistance.

FIG. 4b illustrates the auxiliary boom 3 being hoisted using only the main wire 7, illustrated by the arrow. The auxiliary boom 3 can automatically be arranged in a hoisting position of the auxiliary boom 3. The hoisting position is determined by the auxiliary boom's center of gravity relative to the further wire handling means 17. The tip engagement means 18 on the auxiliary boom 3 is facing the crane system 1, while being hoisted. The main boom 2 is boomed into gradually elevated position as the auxiliary boom 3 approaches the main boom 2.

FIG. 4c illustrates the auxiliary boom 3 reaching the tip end of the main boom 2. The auxiliary boom is arranged relative to the main boom, such that the auxiliary boom 3 is facing the main boom 2, when holding the auxiliary boom 3 with the main wire 7. By tensioning the main wire 7, the hoisting end of auxiliary boom 3 will be displaced in an elevated position relative to the main boom 2. The complementary engagement means 21 on the tip end of the main boom 2 is ready to receive the tip engagement means 18 on the auxiliary boom 3, as the hoisting end of the auxiliary boom is being displaced relative to the main boom 2.

The complementary engagement means 21 on the tip end of the main boom 2 and the tip engagement means 18 on the auxiliary boom 3 forms a joint connected by the main wire 7, before the complementary engagement means 21 and the tip engagement means 18 are releasably locked together. The complementary engagement means 21 and the tip engagement means 18 form a pair of forces, which through the joint substantially forms a force couple, which forces the auxiliary boom 3 to move into an installation position relative to the main boom 2, as the main wire 7 is being tensioned. The main boom 2 may be in a position between a substantially horizontal position and a vertical position, when auxiliary boom moves into a substantially parallel position relative to the main boom, wherein the joint angle o between the main boom 2 and the auxiliary boom 3 is decreasing as the main wire 7 is being tensioned.

FIG. 4d illustrates the auxiliary boom's 3 tip engagement means reaching the complementary engagement means of the main boom 2. While tensioning the main wire 7, the crane system 1 is capable of positioning the auxiliary boom 3 next to the main boom 2. The auxiliary boom 3 is positioned substantially parallel to the main boom 2, when the wire is tensioned. The auxiliary boom 3 is positioned in an upright position substantially parallel the main boom 2 and/or crane base 5. The complementary engagement means 21 on the tip end of the main boom 2 receives the tip engagement means 18 on the auxiliary boom 3 in a releasable locked position. Due to the main boom's 2 upright position movement and the auxiliary boom's 3 pendulum movement, the auxiliary boom's base end moves toward the crane base 5 partially encapsulating the main boom 2 at the same time. An upright position movement shall be understood as the movement when performing the task of lifting up the tip end 10 of the main boom 2 relative to the base end 11 of the main boom 2.

FIG. 4e illustrates the auxiliary boom 3 being releasably locked to the boom mounting bracket 23 on the crane base 5, while enclosing the main boom 2 partially. The auxiliary boom's 3 attachment means 19 is used for releasable locking the auxiliary boom 3 to the crane base 5 to the boom mounting bracket 23. The auxiliary boom is now attached to the main boom 2 and/or to the crane base 5. The center of rotation for the auxiliary is substantially the same as the main boom 2.

The main wire 7 is arranged in and/or through the auxiliary boom's 3 wire handling means 16, such that crane system's 1 lifting capacity and radius is defined by the auxiliary boom, while using the main wire 7 for hoisting a load.

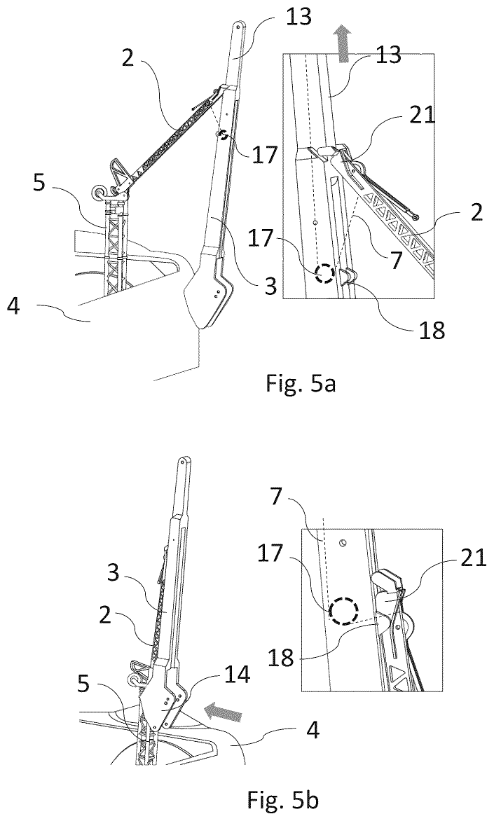

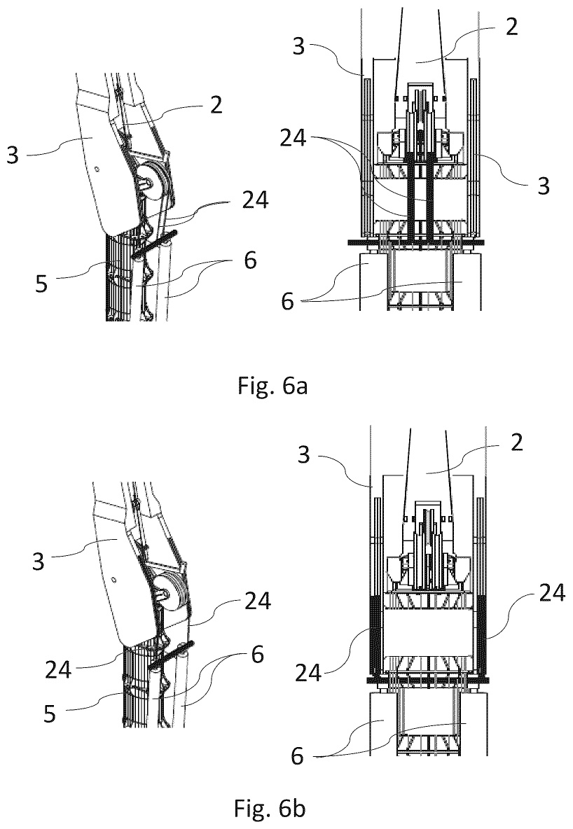

FIG. 5 a, b shows a further embodiment of crane system 1 installing an auxiliary boom 3. The installation of the auxiliary boom is substantially similar to the installation described in FIG. 4 a, b, c, d, e. The auxiliary boom 3 reaches the tip end of the main boom 2. The auxiliary boom 3 is arranged relative to the main boom 2, such that the auxiliary boom is facing the main boom 2, when holding the auxiliary boom 3 with the main wire 7. By tensioning the main wire 7, the hoisting end 13 of auxiliary boom 3 will be displaced in an elevated position relative to the main boom 2. The complementary engagement means 21 on the tip end of the main boom 2 is ready to receive the tip engagement means 18 on the auxiliary boom 3, as the hoisting end 13 of the auxiliary boom 3 is being displaced upwards relative to the main boom 2. While tensioning the main wire 7, the crane system 1 is capable of positioning the auxiliary boom 3 next to the main boom 2. The auxiliary boom 3 is positioned substantially parallel to the main boom 2. The auxiliary boom 3 is positioned in an upright position substantially parallel the main boom 2 and/or crane base 5, in an upright position where the tip end of the main boom 2 is lifted in a substantially vertical position above the crane base 5. The tip engagement means 18 on the auxiliary boom 3 slides up and is received by the complementary engagement means 21 on the tip end of the main boom 2. The complementary engagement means 21 on the tip end of the main boom 2 receives the tip engagement means 18 on the auxiliary boom 3 in a releasably locked position, when tensioning the wire. Due to the main boom's 2 upright position movement and the auxiliary boom's 3 movement, the auxiliary boom's base end 13 moves toward the crane base 5 partially encapsulating the main boom 2 at the same time. The auxiliary boom's 3 base is releasable fastened to the crane system 1.
FIG. 6 a, b shows an embodiment of connecting moving means 6 from the main boom 2 to the auxiliary boom 3 using connection means 24. The connection means may comprise a wire rope or similar, to connect the moving means to the main boom 2 or the auxiliary boom 3. The moving means may be hydraulically, electrically and/or pneumatically driven moving means 6. The crane system 1 controls the two moving means 6. In FIG. 6a, the moving means 6 and the connection means 24 are arranged in a first connection position relative to the moving means 6 and moveable attached to the main boom 2, such that the crane system 1 is capable of controlling the movement of the main boom 2. In FIG. 6b, the moving means 6 and the connection means 24 is arranged in a second connection position relative to the moving means 6 and moveably attached to the auxiliary boom 3, such that the crane system 1 is capable of controlling the movement of the auxiliary boom 3.

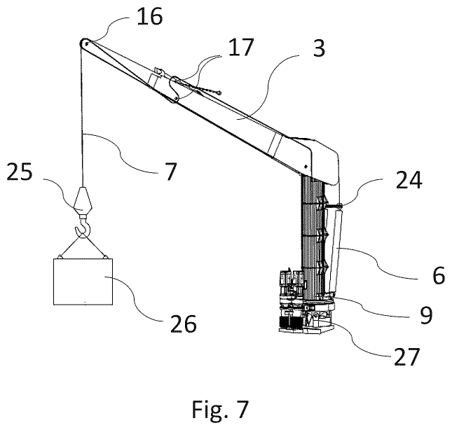

FIG. 7 illustrates reconnection of a main boom's 2 moving means 6 to an auxiliary boom 3. The auxiliary boom 3 comprises connection means 24. The connection means 24 is used for connection to the main boom's moving means to the auxiliary boom 3, such that the crane system is capable of controlling said auxiliary boom 3 with the moving means 6 from the main boom 2. The crane system 1 is capable of using moving means 6 to operate the auxiliary boom 3, when the moving means 6 is moveable connected to the base end of the auxiliary boom 3. The longitudinal length of the auxiliary boom 3 is longer than the longitudinal length of the main boom 2. The auxiliary boom 3 encloses at least partially the base end 11 of said main boom 2. The crane system 1 having the auxiliary boom 3 installed, hoisting load 26 using the main wire 7.

### LIST OF DESIGNATIONS

1 Crane system
2 Main boom
3 Auxiliary boom
4 Construction
5 Crane base
6 Moving means
7 Main wire
8 Upper part of the crane base
9 Bottom part of the crane base
10 Tip end of the main boom
11 Base end of the main boom
12 Boom part of the main boom
13 Hoisting end of the auxiliary boom
14 Base end of the auxiliary boom
15 Boom part of the auxiliary boom
16 Wire handling means for handling the main wire
17 Further wire handling means for handling the main wire
18 Tip engagement means
19 Attachment means for attachment to the crane base
20 Hoisting part of the auxiliary boom
21 Complementary engagement means
22 Further base attachment means
23 Boom mounting bracket
24 Connection means for connection to moving means
25 Hook
26 Load
27 Crane mounting means

1. A method for installing an auxiliary boom in a crane system, the crane system comprising a main boom, a crane base, a tip end and a main wire, wherein the method comprises following steps:
providing the auxiliary boom, wherein the auxiliary boom comprises a hoisting end, a base end, and a boom part, wherein the boom part is arranged between the hoisting end and the base end, and at least one wire handling means;
arranging said main wire in a hoisting grip in said wire handling means at the hoisting end of the auxiliary boom;
hoisting the auxiliary boom using the main wire, wherein a hoisting position of the auxiliary boom is determined by the auxiliary boom's center of gravity;
arranging the auxiliary boom or part of auxiliary boom relative to said main boom, when holding the auxiliary boom with the main wire;
attaching the auxiliary boom to the main boom and/or to the crane base, when holding the auxiliary boom with the main wire, in a position wherein the auxiliary boom or part of the auxiliary boom is arranged along the main boom, and
arranging the main wire in and/or through the auxiliary boom's wire handling means, such that the crane system's lifting capacity is defined by the auxiliary boom, while using the main wire for hoisting a load.

2. The method according to claim 1, wherein the method comprises a further step of pulling the main wire through a further wire handling means arranged between the hoisting end and the base end of the auxiliary boom to the wire handling means at the hoisting end of the auxiliary boom.

3. The method according to claim 2, wherein the method comprises further steps of:
using the main wire for hoisting the auxiliary boom up to said tip end of the main boom;
lifting the tip end of the main boom relative to the base end of the main boom, while positioning the auxiliary boom in a position substantially parallel to the main boom; and-[[-]] attaching the auxiliary boom to the main boom and/or crane base in a releasably locked position, while the auxiliary boom and main boom are in an upright position.

4. The method according to claim 3, wherein the method comprises a further step of attaching the tip end of the main boom to at least one tip engagement means provided on the auxiliary boom.

5. The method according to any claim 1, wherein the method comprises further steps of:
attaching the main boom at least one moving means to the auxiliary boom and;
using moving means to operate the auxiliary boom.

6. An auxiliary boom for a crane system comprising a main boom, a crane base, a tip end, at least one moving means and a main wire, wherein the auxiliary boom comprises:
a hoisting end and a base end, and a boom part arranged between the hoisting end and the base end;
at least one base attachment means arranged at the base end, wherein the base attachment means is configured to be attached to the crane bas;
at least one tip engagement means arranged at a position away from base attachment means, wherein the tip attachment means is configured to receive the main boom's tip end in an engagement position; and
at least one wire handling means, wherein at least one of the wire handling means is arranged in the hoisting end, and wherein the wire handling means is configured to receive the main wire from the main boom.

7. The auxiliary boom according to claim 6, wherein the tip engagement means is provided at the hoisting end, or between the hoisting end and base end.

8. The auxiliary boom according to claim 7, wherein a further wire handling means is arranged in a position between the hoisting end and base end of the auxiliary boom, such that a center of gravity of the auxiliary boom is placed between the further wire handling means and the base end of the auxiliary boom.

9. The auxiliary boom according to claim 6, wherein the auxiliary boom is configured to partially enclose the main boom or part of the main boom.

10. The auxiliary boom according to claim 6, wherein the auxiliary boom comprises a first and a second boom side configured to be arranged on each side of a main boom, wherein a base end of each of said first and said second boom side is configured to be arranged on each side of a crane base, said first and said second boom side each comprising a side end opposite the base end, which are connected to a hoisting part with a hoisting end.

11. The auxiliary boom according to claim 6, wherein the base end comprises at least one connection means for attachment to a crane base and/or a main boom's moving means, such that a crane system is capable of controlling the movement of the auxiliary boom during operation.

12. A crane system for construction of a building, wherein the crane system comprises a main boom and an auxiliary boom, wherein the crane system is configured to install said auxiliary boom to said main boom on a crane, wherein the auxiliary boom is configured to enclose at least partially a base end of said main boom.

13. The crane system according to claim 12, wherein a length in a longitudinal direction of the auxiliary boom is longer than a length in a longitudinal direction of the main boom.

14. The crane system according to claim 12, wherein said auxiliary boom is configured to hoisting a load using a main wire.

15. The crane system according to claim 12, wherein said auxiliary boom comprises connection means configured for connection to the main boom's moving means, such that the crane system is capable of controlling said auxiliary boom with the moving means for the main boom.

16. The method according to claim 1, wherein the method comprises further steps of:
using the main wire for hoisting the auxiliary boom up to said tip end of the main boom;
lifting the tip end of the main boom relative to the base end of the main boom, while positioning the auxiliary boom in a position substantially parallel to the main boom; and
attaching the auxiliary boom to the main boom and/or crane base in a releasably locked position, while the auxiliary boom and main boom are in an upright position.

17. The method according to claim 16, wherein the method comprises a further step of attaching the tip end of the main boom to at least one tip engagement means provided on the auxiliary boom.

18. The method according to claim 1, wherein the method comprises a further step of attaching the tip end of the main boom to at least one tip engagement means provided on the auxiliary boom.

19. The method according to claim 2, wherein the method comprises a further step of attaching the tip end of the main boom to at least one tip engagement means provided on the auxiliary boom.

20. The auxiliary boom according to claim 6, wherein a further wire handling means is arranged in a position between the hoisting end and base end of the auxiliary boom, such that a center of gravity of the auxiliary boom is placed between the further wire handling means and the base end of the auxiliary boom.
